(19) United States
(12) Patent Application Publication
(10) Pub. No.: US 2021/0183331 A1
(43) Pub. Date: Jun. 17, 2021

(54) DISPLAY DEVICE AND DRIVING METHOD THEREOF

(71) Applicants: Beijing BOE Optoelectronics Technology Co., Ltd., Beijing (CN); BOE TECHNOLOGY GROUP CO., LTD., Beijing (CN)

(72) Inventors: Hong Liu, Beijing (CN); Yankai Gao, Beijing (CN); Guofeng Hu, Beijing (CN); Mingjian Yu, Beijing (CN); Yuxin Bi, Beijing (CN); Wei Chen, Beijing (CN)

(21) Appl. No.: 16/972,690

(22) PCT Filed: May 29, 2020
(86) PCT No.: PCT/CN2020/093305

§ 371 Date: Dec. 7, 2020

(30) Foreign Application Priority Data
Jun. 12, 2019 (CN) 201910507418.4

(51) Int. Cl. G09G 5/00; G06F 3/14

(52) U.S. Cl. CPC G09G 5/005; G06F 3/1431; G09G 2370/08; G09G 2370/14; G09G 2370/12; G09G 2360/02

(57) ABSTRACT

The present disclosure provides a display device and a driving method thereof, which relate to a field of display technology. According to the present disclosure, first image data and second image data are merged by using a graphics processor. The merged image data may be transmitted to a control chip through only one interface. Then the merged image may be split by the control chip to obtain first image data and third image data, which are respectively transmitted to a first driving chip and a second driving chip to drive a first display panel and a second display panel to display, wherein the third image data is at least partially the same as the second image data.

### CROSS REFERENCE TO RELATED APPLICATIONS

This application is a Section 371 National Stage Application of International Application No. PCT/CN2020/093305, filed on May 29, 2020, entitled “DISPLAY DEVICE AND DRIVING METHOD THEREOF”, which claims priority to Chinese Patent Application No. 201910507418.4, filed on Jun. 12, 2019, the contents of which are incorporated herein by reference in their entireties.

### TECHNICAL FIELD

The present disclosure relates to a field of display technology, and in particular to a display device and a driving method thereof.

### BACKGROUND

With a continuous development of display technology, dual-screen display has gradually become an important development direction in the display field. Displaying with two displays can bring users a better experience.

At present, a dual-screen display device may include a graphics processor and two display screens including a first display screen and a second display screen. When the first display screen and the second display screen have different sizes and specifications, based on constraints of data volume and transfer protocols, it is usually necessary to occupy two different interfaces in the graphics processor in order to drive the first display screen and the second display screen with different sizes and specifications for display. The more interfaces occupied in the graphics processor, the more transfer protocols required for data transmission, and the greater the cost. Moreover, if more interfaces are occupied in the graphics processor, the structure and connection of the display device will be more complicated.

### SUMMARY

The present disclosure provides a display device and a driving method thereof.

According to an aspect of the present disclosure, there is provided a display device including a graphics processor, a control circuit, a first display panel and a second display panel. The graphics processor includes a first interface and is configured to: merge first image data and second image data to obtain merged image data, and transmit the merged image data via the first interface. The control circuit includes a second interface and a third interface and is configured to: receive the merged image data, split the merged image data into first image data and third image data, transmit the first image data via the second interface, and transmit the third image data via the third interface, wherein the third image data is at least partially the same as the second image data. The first display panel is configured to receive the first image data and display a first image based on the first image data. The second display panel is configured to receive the third image data and display a third image based on the third image data.

For example, the first image data includes M first pixel data, and the second image data includes N second pixel data, where M is an integer greater than 1, and N is an integer greater than M. The graphics processor is configured to replace M second pixel data located at a specified position in the N second pixel data with the M first pixel data based on a first mapping relationship, so that the merged image data includes N-M second pixel data and the M first pixel data. The first mapping relationship includes a position mapping relationship between the M first pixel data and the M second pixel data.

For example, the control circuit is configured to: split the merged image data into the M first pixel data and the N-M second pixel data based on the first mapping relationship, so that the first image data includes the M first pixel data, and image data to be processed includes the N-M second pixel data and M pixel voids located at the specified position; determine, for each pixel void in the M pixel voids, pixel data for the each pixel void according to second pixel data adjacent to the each pixel void in the N-M second pixel data; and perform data filling at the specified position in the image data to be processed based on the pixel data for the each image void, so as to obtain the third image data.

For example, the M second pixel data at the specified position includes M second pixel data for an edge position of a display unit of the second display panel.

For example, the first image data includes M first pixel data, and the second image data includes N second pixel data, where M is an integer greater than 1, and N is an integer greater than M. The graphics processor is configured to splice the M first pixel data and the N second pixel data based on a second mapping relationship so as to obtain the merged image data. The second mapping relationship includes: a position mapping relationship of the M first pixel data from the first image data to the merged image data, and a position mapping relationship of the N second pixel data from the second image data to the merged image data. The control circuit is configured to: split the merged image data into the M first pixel data and the N second pixel data based on the second mapping relationship, so that the first image data includes the M first pixel data, and the third image data includes the N second pixel data. In this case, the third image data is the same as the second image data.

For example, the graphics processor is further configured to: compress the merged image data based on a predetermined compression algorithm so as to obtain compressed data, and transmit the compressed data to the control circuit via the first interface. The control circuit is further configured to decompress the compressed data based on a decompression algorithm for the predetermined compression algorithm so as to obtain the merged image data.

For example, the predetermined compression algorithm includes at least one of a run length encoding algorithm and a fractal compression algorithm.

For example, the second interface is an MIPI interface, and the third interface is an LVDS interface. The control circuit further includes a first control circuit and a second control circuit. The first control circuit is configured to convert the first image data into MIPI format data and transmit the MIPI format data to the first display panel via the second interface. The second control circuit is configured to convert the third image data into LVDS format data and generate a timing control signal, and transmit the LVDS format data and the timing control signal to the second display panel via the third interface.

For example, the first control circuit is a bridge integrated circuit, and the second control circuit is a timing controller.

For example, the first interface is an eDP interface or an HDMI interface.

According to another aspect of the present disclosure, there is provided a driving method of a display device, performed by the display device described above. The method includes: merging first image data and second image data by using a graphics processor so as to obtain merged image data, and transmitting the merged image data to a control circuit via a first interface; splitting the merged image data into first image data and third image data by using the control circuit, transmitting the first image data to a first display panel via a second interface, and transmitting the third image data to a second display panel via a third interface, wherein the third image data is at least partially the same as the second image data; displaying a first image according to the first image data by using the first display panel; and displaying a third image according to the third image data by using the second display panel.

For example, the first image data includes M first pixel data, and the second image data includes N second pixel data, where M is an integer greater than 1, and N is an integer greater than M. The merging first image data and second image data includes: replacing M second pixel data located at a specified position in the N second pixel data with the M first pixel data based on a first mapping relationship, so that the merged image data includes N-M second pixel data and the M first pixel data. The first mapping relationship includes a position mapping relationship between the M first pixel data and the M second pixel data.

For example, the splitting the merged image data into first image data and third image data includes: splitting the merged image data into the M first pixel data and the N-M second pixel data based on the first mapping relationship, so that the first image data includes the M first pixel data, and image data to be processed includes the N-M second pixel data and M pixel voids located at the specified position; determining, for each pixel void in the M pixel voids, pixel data for the each pixel void according to second pixel data adjacent to the each pixel void in the N-M second pixel data, and performing data filling at the specified position in the image data to be processed based on the pixel data for the each image void, so as to obtain the third image data.

For example, the M second pixel data at the specified position includes M second pixel data for an edge position of a display unit of the second display panel.

For example, the first image data includes M first pixel data, and the second image data includes N second pixel data, where M is an integer greater than 1, and N is an integer greater than M. The merging first image data and second image data includes: splicing the M first pixel data and the N second pixel data based on a second mapping relationship so as to obtain the merged image data. The second mapping relationship includes: a position mapping relationship of the M first pixel data from the first image data to the merged image data, and a position mapping relationship of the N second pixel data from the second image data to the merged image data. The splitting the merged image data into first image data and third image data includes: splitting the merged image data into the M first pixel data and the N second pixel data based on the first mapping relationship, so that the first image data includes the M first pixel data, and the third image data includes the N second pixel data. In this case, the third image data is the same as the second image data.

For example, the method further includes: compressing the merged image data based on a predetermined compression algorithm by using the graphics processor so as to obtain compressed data; and decompressing the compressed data based on a decompression algorithm for the predetermined compression algorithm by using the control circuit so as to obtain the merged image data. The transmitting the merged image data to the control circuit via the first interface includes: transmitting the compressed data to the control circuit via the first interface.

For example, the predetermined compression algorithm includes at least one of a run length encoding algorithm and a fractal compression algorithm.

### BRIEF DESCRIPTION OF THE DRAWINGS

FIG. 1 shows a structure diagram of a dual-screen display device;

FIG. 2 shows a structure diagram of a display device according to an embodiment of the present disclosure;

FIG. 3 shows an exemplary structure diagram of a display device according to an embodiment of the present disclosure;

FIG. 4 shows an exemplary structure diagram of another display device according to an embodiment of the present disclosure;

FIG. 5 shows a flowchart of a driving method of a display device according to an embodiment of the present disclosure;

FIG. 6 shows an exemplary diagram of a merging process and splitting process of image data according to an embodiment of the present disclosure; and

FIG. 7 shows an exemplary diagram of another merging process and splitting process of image data according to an embodiment of the present disclosure.

### DETAILED DESCRIPTION

In order to make the above objectives, features and advantages of the present disclosure more obvious and understandable, the present disclosure will be further described in detail below with reference to the drawings and specific embodiments.

FIG. 1 schematically shows a structure diagram of a dual-screen display device. As shown in FIG. 1, the dual-screen display device may generally include: a graphics processing unit (GPU) 11, a first control chip 12, a first display panel 13, a second control chip 14 and a second display panel 15. The graphics processor 11, the first control chip 12 and the first display panel 13 are electrically connected in sequence. The first display panel 13 may include a first driving chip 131 and a first display unit 132. The graphics processor 11, the second control chip 14 and the second display panel 15 are electrically connected in sequence. The second display panel 15 may include a second driving chip 151 and a second display unit 152.

Since the first display panel 13 and the second display panel 15 have different sizes and specification, based on industry standards and under constraints of data volume and transfer protocols, it is needed to occupy two different interfaces, such as an interface 1 and an interface 2 in the graphics processor 11 in order to drive the first display panel 13 and the second display panel 15 with different sizes and specifications for display. The graphics processor 11 is electrically connected to the first control chip 12 through the interface 1, and transmits image data to be displayed on the first display panel 13 to the first control chip 12 through the interface 1. The first control chip 12 transmits the image data to be displayed on the first display panel 13 to the first driving chip 131. The first driving chip 131 drives the first display unit 132 to display according to the image data received. Correspondingly, the graphics processor 11 is connected to the second control chip 14 through the interface 2, and transmits image data to be displayed on the second display panel 15 to the second control chip 14 via the interface 2. Then, the image data received is transmitted by the second control chip 14 to the second driving chip 151. The second driving chip 151 drives the second display unit 152 to perform displaying according to the image data received.

For example, the first display panel 13 may be a small-size display panel, such as a 7-inch display panel. In order to drive the small-size first display panel 13 to perform displaying, an HDMI (High Definition Multimedia Interface) in the graphics processor 11 needs to be occupied, that is, the interface 1 is an HDMI interface. For example, the second display panel 15 is a large-size display panel, such as a 14-inch display panel. In order to drive the large-size second display panel 15 to perform displaying, an eDP (Embedded Display Port) in the graphics processor 11 needs to be occupied, that is, the interface 2 is an eDP interface. Therefore, in the dual-screen display device shown in FIG. 1, in order to drive the first display panel 13 and the second display panel 15 to display, the eDP interface and the HDMI interface in the graphics processor 11 need to be occupied at the same time.

When the graphics processor 11 have different interfaces for the first control chip 12 and the second control chip 14, the image data of the graphics processor 11 is transmitted to the first control chip 12 and the second control chip 14 respectively under different transfer protocols. The more transfer protocols used, the greater the cost. In addition, since the graphics processor 11 is electrically connected to the first control chip 12 and the second control chip 14 respectively through two different interfaces, at least two signal lines are required for connection, which makes the structure and connection of the display device more complicated.

The display device provided by the present disclosure merges first image data and second image data by using the graphics processor so as to obtain merged image data, and transmits the merged image data to the control circuit via the first interface. The control circuit splits the merged image data into first image data and third image data which is at least partially the same as the second image data. The control circuit transmits the first image data and the third image data respectively to the first display panel and the second display panel, so as to achieve the dual-screen display. The solution only needs to occupy one interface of the graphics processor to drive the first display panel and the second display panel, and only one transfer protocol is used, which can reduce the cost of data transmission and simplify the structure and connection of the display device.

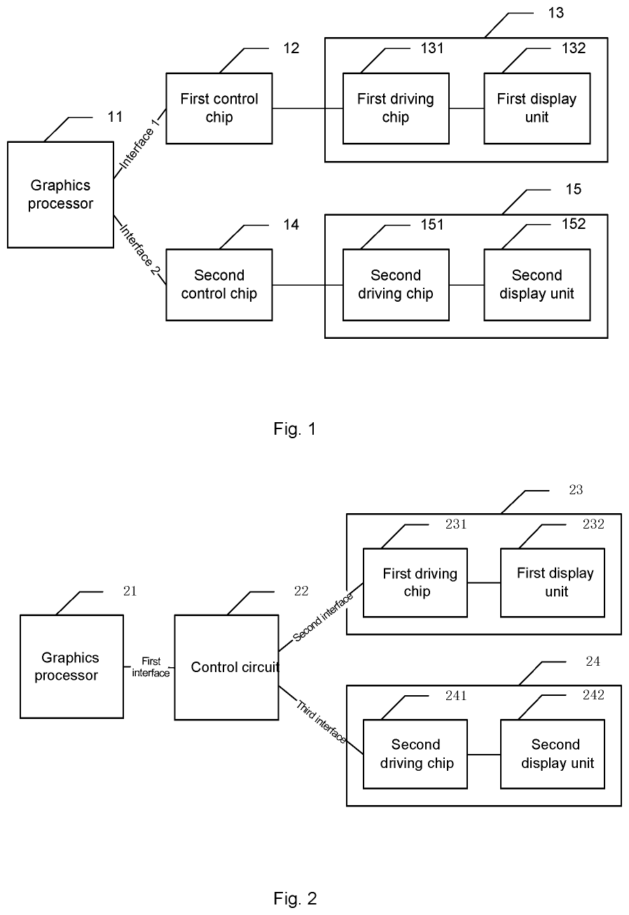

According to an embodiment of the present disclosure, there is proposed a display device. FIG. 2 shows a structure diagram of a display device according to an embodiment of the present disclosure.

As shown in FIG. 2, the display device according to the embodiment of the present disclosure may include a graphics processor 21, a control circuit 22, a first display panel 23 and a second display panel 24. Exemplarily, the control circuit 22 may be a control chip 22, for example. The first display panel 23 may include, for example, a first driving chip 231 and a first display unit 232. The second display panel 24 may include, for example, a second driving chip 241 and a second display unit 242.

The graphics processor 21 includes a first interface and is electrically connected to the control chip 22 via the first interface. The graphics processor 21 is configured to merge first image data and second image data to obtain merged image data, and transmit the merged image data to the control chip 22 via the first interface. The control chip 22 includes a second interface and a third interface. The control chip 22 is electrically connected to the first driving chip 231 via the second interface and is connected to the second driving chip 241 via the third interface. The control chip 22 is configured to split the merged image data into first image data and third image data, wherein the third image data is at least partially the same as the second image data. The control chip 22 transmits the first image data to the first driving chip 231 via the second interface, and transmits the third image data to the second driving chip 241 via the third interface. The first driving chip 231 is configured to control the first display unit 232 to display a first image according to the first image data. The second driving chip 241 is configured to control the second display unit 242 to display a third image according to the third image data.

It may be understood that the display device according to the embodiment of the present disclosure adds an image data merging function to the graphics processor 21 and provides the control chip 22 in which an image data splitting function is added accordingly. Therefore, the first image data that needs to be displayed on the first display panel 23 and the second image data that needs to be displayed on the second display panel 24 are merged in the graphics processor 21 so as to obtain the merged image data. The graphics processor 21 transmits the merged image data to the control chip 22 via the first interface. The control chip 22 splits the merged image data to obtain the first image data and the third image data that is at least partially the same as the second image data, and then transmits the first image data and the third image data to the first driving chip 231 and the second driving chip 241 respectively to drive the first display unit 232 and the second display unit 242 to perform displaying. Therefore, only one interface in the graphics processor 21 is required to drive the first display panel 23 and the second display panel 24, and only one transfer protocol is required to transmit the merged image data of the graphics processor 21 to the control chip 22, which reduces the cost of transfer protocol. In addition, only one control chip 22 needs to be provided, and only one signal line is needed to connect the graphics processor 21 and the control chip 22, which simplifies the structure and connection of the display device.

It should be noted that the third image data may be the same as or partially different from the second image data. However, if the third image data is different from the second image data, when the third image is displayed on the second display panel 24 according to the third image data, only the definition of some positions is reduced compared to the second image, and the display effect is not affected.

For example, the first interface may be an eDP interface or an HDMI interface, the second interface may be an MIPI (Mobile Industry Processor Interface) interface, and the third interface may be an LVDS (Low Voltage Differential Signaling) interface. The above are only examples, and the types of the above interfaces may be selected according to actual needs, which are not limited here.

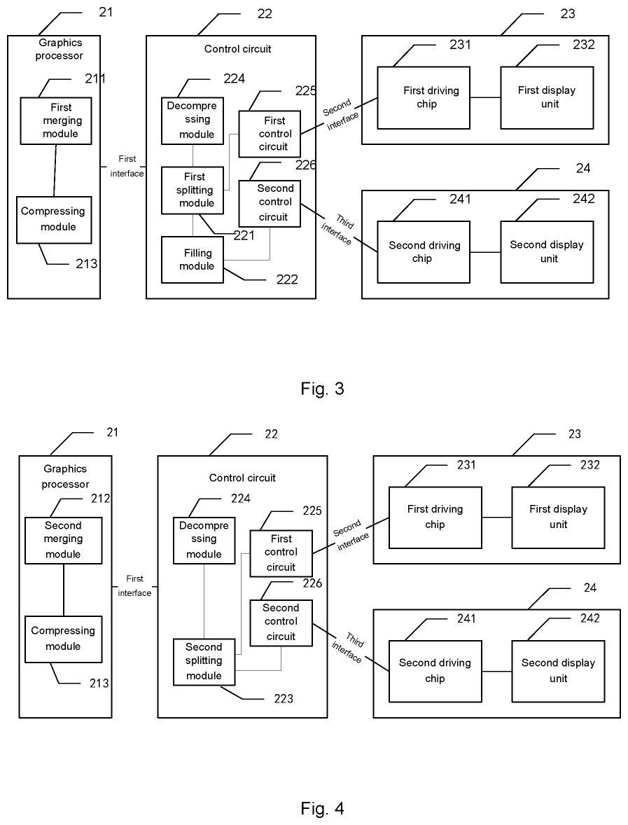

In an embodiment of the present disclosure, a scheme for merging and corresponding splitting of image data may be provided. As shown in FIG. 3, the graphics processor 21 may include a first merging module 211, and the control chip 22 may include a first splitting module 221 and a filling module 222.

The first merging module 211 is configured to replace image data at a specified position of the second image data with the first image data, so as to obtain the merged image data. The first splitting module 221 is configured to split the merged image data into first image data and image data to be processed. The filling module 222 is configured to perform data filling on the image data to be processed according to image data located adjacent to the specified position, so as to obtain the third image data.

Exemplarily, the first image data may include M first pixel data, and the second image data may include N second pixel data. In this embodiment, it is assumed that the first display panel has a size smaller than that of the second display panel, so M is an integer greater than 1, and N is an integer greater than M. The first merging module 211 is configured to determine M second pixel data located at the specified position based on a first mapping relationship, and replace the M second pixel data located at the specified position in the N second pixel data with the M first pixel data in the first image data, so that the merged image data includes remaining N-M second pixel data in the second image data and the M first pixel data in the first image data. The first mapping relationship may include a position mapping relationship between the M first pixel data and the M second pixel data. According to this embodiment, the merged image data has the same data volume as the second image data and does not increase the occupation of subsequent transmission bandwidth.

The graphics processor 21 transmits the merged image data to the control circuit 22 via the first interface, and the control circuit 22 splits the merged image data. For example, the first splitting module 221 in the control circuit 22 may be configured to determine positions of the M first pixel data and positions of the N-M second pixel data in the merged image data based on the first mapping relationship. Thus, the merged image data may be split into the M first pixel data and the N-M second pixel data, so that the first image data includes the M first pixel data, and the image data to be processed includes the N-M second pixel data and M pixel voids located at the specified position. The filling module 222 in the control circuit 22 may be configured to determine, for each pixel void in the M pixel voids of the image data to be processed, pixel data for the each pixel void according to second pixel data adjacent to the each pixel void in the N-M second pixel data so as to determine pixel data for each of the M pixel voids in the image data to be processed, and then perform data filling at the specified position in the image data to be processed based on the pixel data for each of the M pixel voids so as to obtain the third image data. According to this embodiment, the third image data split by the control circuit 22 and the second image data have different pixel data at the specified position.

In an embodiment of the present disclosure, in order to make a subsequent display effect of the second display panel for the third image data as close as possible to a display effect of the second display panel for the second image data, the following scheme may be adopted for the data filling at the specified position. Exemplarily, when the control circuit 22 determines the pixel data for each pixel void, a second pixel data located adjacent to a certain pixel void may be directly used as the second pixel data for the pixel void. In other embodiments, the control circuit 22 may also perform interpolation calculations based on a plurality of second pixel data located adjacent to the pixel void, so as to obtain the pixel data for the pixel void. According to the above embodiments, the pixel data located at the specified position and the pixel data located at the non-specified position in the third image data may be smoothed, thereby reducing the influence of the filling data on the display effect.

According to an embodiment of the present disclosure, in order to further reduce the influence of the filling data on the display effect at the specified position, the image data at the specified position may be image data at a non-visual center frame, which may be understood as the image data located at an edge of the display unit when the image data is displayed on the display unit. For example, if the size of the second display panel is 1092 pixels×1080 pixels, the M second pixel data located at the specified position in the second image data may include the second pixel data in the 1^{st} row, the pixel data in the 1080^{th} row, the second pixel data in the 1^{st} column, and the second pixel data in the 1092^{nd} column.

It may be understood that, in the foregoing embodiment, the graphics processor 21 is provided with the first merging module 211, and the control chip 22 is provided with the first splitting module 221 and the filling module 222. The merging algorithm of the first merging module 211 matches the splitting algorithm of the first splitting module 221.

The first merging module 21 replaces the image data at the specified position of the second image data with the first image data so as to obtain the merged image data. The merged image data has the same size as the second image data. The graphics processor 21 transmits the merged image data to the control chip 22 via the first interface, and the first splitting module 221 in the control chip 22 splits the merged image data into the first image data and the image data to be processed. The image data to be processed refers to the image data remaining after the first image data is split from the merged image data. Compared with the second image data, the image data to be processed lacks image data at the specified position. Therefore, the filling module 222 needs to perform data filling on the image data to be processed according to the image data located adjacent to the specified position so as to obtain the third image data.

It should be noted that the second image data and the third image data are the same at the non-specified position, but are different at the specified position. When the graphics processor 21 replaces the image data at the specified position of the second image data with the first image data, the image data at the non-visual center frame may be replaced. Generally, when an image is displayed on a display panel, an area viewed by a human eye is an area at the visual center frame, and an area at the non-visual center frame is usually not noticed by the human eye. Therefore, the data filling is performed on the image data to be processed according to the image data located adjacent to the specified position, so as to obtain the third image data. The third image data only reduces the definition at the specified position. When the second display panel 24 displays the third image according to the third image data, the display effect of the third image is not affected and may be as close as possible to the display effect of the second image.

Therefore, without affecting the display effects of the first image and the third image, when the graphics processor 21 transmits the merged image data to the control chip 22, the amount of data transmission is reduced, thereby increasing the rate of data transmission.

In another embodiment of the present disclosure, another scheme for merging and corresponding splitting of image data may be provided. As shown in FIG. 4, the graphics processor 21 may include a second merging module 212, and the control chip 22 may include a second splitting module 223. The second merging module 212 is configured to add the first image data to any position of the second image data, so as to obtain the merged image data. The second splitting module 223 is configured to split the merged image data into first image data and third image data. In this case, the third image data is the same as the second image data, and a lossless merging and splitting process may be achieved.

Exemplarily, the first image data may include M first pixel data, and the second image data may include N second pixel data, where M is an integer greater than 1, and N is an integer greater than M. The second merging module 212 in the graphics processor 21 is configured to determine a splicing position based on the second mapping relationship, and splice the M first pixel data and the N second pixel data so as to obtain the merged image data. The second mapping relationship may include a position mapping relationship of the M first pixel data from the first image data to the merged image data, and a position mapping relationship of the N second pixel data from the second image data to the merged image data. Correspondingly, the second splitting module 223 in the control circuit 22 may be configured to split the merged image data into the M first pixel data and the N second pixel data based on the second mapping relationship, so that the first image data includes the M first pixel data, and the third image data includes the N second pixel data. The third image data is exactly the second image data.

It may be understood that, the graphics processor 21 is provided with the second merging module 212, and the control chip 22 is provided with the second splitting module 223. The merging algorithm of the second merging module 212 matches the splitting algorithm of the second splitting module 223.

The second merging module 212 adds the first image data to any position of the second image data, such as before or after the first image data, so as to obtain the merged image data. The merged image data has a size equal to the sum of the size of the first image data and the second image data. The merged image data is transmitted to the control chip 22 via the first interface, and split by the second splitting module 223 to obtain the first image data and the third image data, where the third image is the same as the second image data. That is, the image data after splitting is exactly the same as the image data before merging.

According to the embodiment of the present disclosure, as shown in FIGS. 3 and 4, the graphics processor 21 may further include a compressing module 213, and the control chip 22 may further include a decompressing module 224. The compressing module 213 is configured to compress the merged image data based on a predetermined compression algorithm so as to obtain compressed data. The decompressing module 224 is configured to decompress the compressed data based on a decompression algorithm for the predetermined compression algorithm so as to obtain the merged image data. The above-mentioned predetermined compression algorithm may be, for example, a Run Length Encoding (RLE) algorithm or a fractal compression algorithm, which is not limited here.

In order to reduce the amount of data transmission between the graphics processor 21 and the control chip 22 and increase the rate of data transmission, the compressing module 213 is provided in the graphics processor 21, and the decompressing module 224 is provided in the control chip 22. The compressing module 213 performs a run length encoding compression on the merged image data to obtain the compressed data. The compressed data is transmitted to the control chip 22 via the first interface and decompressed by the decompressing module 224 in the control chip 22 so as to obtain the merged image data.

The run length encoding compression specifically refers to using two bytes to represent adjacent pixels with the same color value in each row of pixels in the image data, where a first byte represents a count value for indicating the number of repetitions of the pixel, and a second byte represent the color value of a specific pixel. For example, if the color value of one row of pixels in the image data is RRRRGGBBB, the compressed data obtained after the run length encoding compression is 4R2G3B. After decompressing the compressed data 4R2G3B, the merged image data RRRRGGBBB may be obtained.

The run length encoding compression is a lossless compression method, which reduces the amount of data transmission between the graphics processor 21 and the control chip 22 and increases the rate of data transmission without loss of image data.

As shown in FIGS. 3 and 4, the control chip 22 further includes a first control circuit 225 and a second control circuit 226. According to the display requirements of the first display panel and the second display panel, when the first display panel has a small size, the first control circuit 225 may be, for example, a Bridge Integrated Circuit (Bridge IC). When the second display panel has a relatively large size, the second control circuit 226 may be, for example, a timing controller. The first control circuit 225 is configured to convert the first image data into MIPI format data. The second control circuit 226 is configured to convert the third image data into LVDS format data and generate a timing control signal.

The control circuit 22 splits the merged image data through the first splitting module 221 and the filling module 222 or through the second splitting module 223 so as to obtain the first image data and the third image data. Then, the control circuit 22 transmits the first image data to the first control circuit 225, and transmits the third image data to the second control circuit 226. The first control module 225 converts the first image data into MIPI format data, and transmits the MIPI format data to the first driving chip 231 via the second interface. The second control circuit 226 converts the third image data into LVDS format data, generates a timing control signal, and transmits the LVDS format data and the timing control signal to the second driving chip 241 via the third interface.

Exemplarily, according to the respective driving requirements of the first display panel and the second display panel, the first driving chip 231 may be a DDIC (Display Driver IC), which has a timing control function integrated therein. The first driving chip 231 controls the first display unit 232 to display the first image according to the first image data. The second driving chip 241 is a general driving chip without a timing control function. Therefore, the second driving chip 24 needs to control the second display unit 242 to display the third image according to the third image data and the timing control signal transmitted by the second control module 226.

It should be noted that the timing control signal includes the timing control signal required by a scan driving circuit and a data driving circuit of the display screen.

The first display panel 23 and the second display panel 24 in the dual-screen display device of the embodiment of the present disclosure may have the same or different sizes and specifications, which are not limited in the embodiment of the present disclosure. In addition, the first display panel 23 and/or the second display panel 24 may further have a touch function.

In the embodiment of the present disclosure, the first image data and the second image data are merged by the graphics processor, and the merged image data is transmitted to the control chip via the first interface. The control chip splits the merged image data into first image data and third image data, transmits the first image data to the first driving chip via the second interface, and transmits the third image data to the second driving chip via the third interface. The first driving chip controls the first display unit to display the first image according to the first image data, and the second driving chip controls the second display unit to display the third image according to the third image data. Through the algorithmic processing of the image data, the first image data and the second image data are merged in the graphics processor, the merged image data may be transmitted to the control chip through only one interface, and then the merged image may be split by the control chip and transmitted to the first driving chip and the second driving chip respectively to drive the first display unit and the second display unit to perform displaying. Therefore, the first display panel and the second display panel may be driven by using only one interface of the graphics processor, and only one transfer protocol is required for data transmission through one interface of the graphics processor, thereby reducing the cost brought by the transfer protocol and also simplifying the structure and connection of the display device.

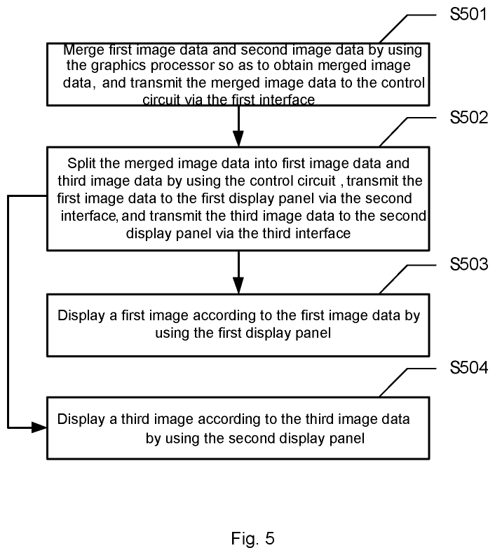

According to an embodiment of the present disclosure, a driving method of a display device is proposed. The method may be performed by the display device as shown in FIGS. 2 to 4. The exemplary structure of the display device has been described in detail above, and will not be repeated here. FIG. 5 shows a flowchart of the driving method of the display device according to an embodiment of the present disclosure. The method may specifically include the following steps.

Step S501: Merge first image data and second image data by using the graphics processor so as to obtain merged image data, and transmit the merged image data to the control circuit via the first interface.

Specifically, in an embodiment of the present disclosure, step S501 may include step A1 of replacing the image data at the specified position in the second image data with the first image data so as to obtain the merged image data. This step may be executed by the first merging module in the graphics processor according to the embodiment of the present disclosure.

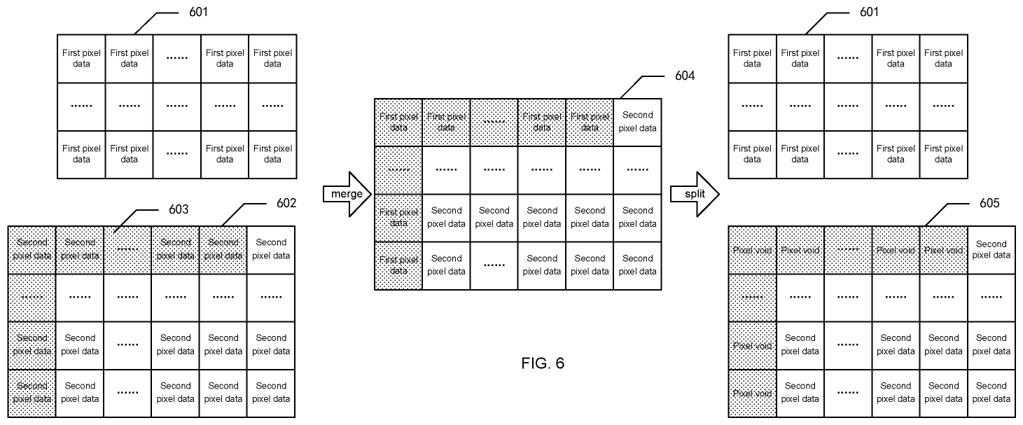

For example, as shown in FIG. 6, first image data 601 includes M first pixel data, and second image data 602 includes N second pixel data, where M is an integer greater than 1, and N is an integer greater than M. The above process of merging the first image data and the second image data may include: replacing M second pixel data located at a specified position 603 (for example, the shaded area) in the N second pixel data with the M first pixel data based on a first mapping relationship, so that merged image data 604 includes N-M second pixel data and the M first pixel data. The first mapping relationship includes a position mapping relationship between the M first pixel data and the M second pixel data.

Specifically, in another embodiment of the present disclosure, step S501 may include step B1 of adding the first image data to any position of the second image data, such as before or after the first image data, so as to obtain the merged image data.

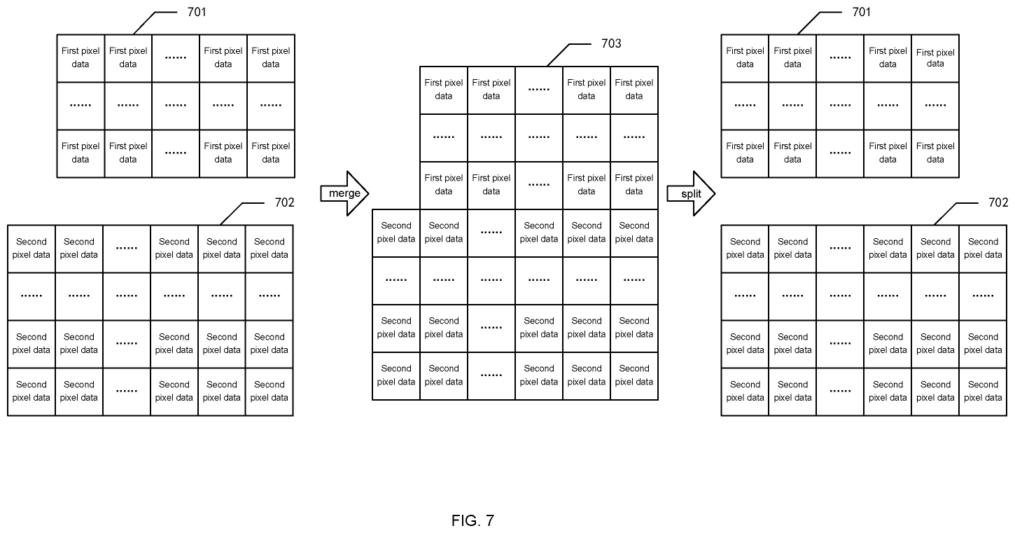

For example, as shown in FIG. 7, the above process of merging the first image data and the second image data may include splicing the M first pixel data 701 and the N second pixel data 702 based on a second mapping relationship so as to obtain merged image data 703. The second mapping relationship includes: a position mapping relationship of the M first pixel data from the first image data to the merged image data, and a position mapping relationship of the N second pixel data from the second image data to the merged image data. This step may be executed by the second merging module in the graphics processor according to the embodiment of the present disclosure.

Step S502: Split the merged image data into first image data and third image data by using the control circuit, transmit the first image data to the first display panel via the second interface, and transmit the third image data to the second display panel via the third interface.

Specifically, in an embodiment of the present disclosure, step S502 may include step A2 of splitting the merged image data into first image data and image data to be processed and step A3 of performing data filling on the image data to be processed according to image data located adjacent to the specified position, so as to obtain the third image data. The steps A2-A3 may be executed by the first splitting module in the control circuit according to the embodiment of the present disclosure.

For example, continuing to refer to FIG. 6, the merged image data 604 is split into the first image data 601 and the image data to be processed 605, so that the first image data 601 includes the M first pixel data, and the image data to be processed 605 includes N-M second pixel data and M pixel voids located at the specified position. Pixel data for each pixel void is determined according to second pixel data adjacent to the each pixel void. Then, data filling is performed at the specified position in the image data to be processed 605 based on the pixel data for the each image void, so as to obtain the third image data.

Specifically, in another embodiment of the present disclosure, step S502 may include step B2 of splitting the merged image data into first image data and third image data. In this case, the third image data is exactly the same as the second image data before merging. This may be executed by the second splitting module in the control circuit according to the embodiment of the present disclosure.

For example, continuing to refer to FIG. 7, the merged image data 703 may be directly split into the first image data 701 and third image data. The third image data is exactly the second image data 702.

Step S503: Display a first image according to the first image data by using the first display panel.

Step S504: Display a third image according to the third image data by using the second display panel.

In the first display panel and the second display panel, the manner in which the driving chips control the display panels to perform displaying has been described in detail above, which is not repeated here.

According to an embodiment of the present disclosure, before the merged image data is transmitted to the control circuit by using the graphics processor, in order to increase the transmission rate of the first interface, the merged image data may be compressed based on a predetermined compression algorithm so as to obtain compressed data. The compressed data is transmitted to the control circuit via the first interface and processed by the control circuit based on a corresponding decompression algorithm so as to obtain the merged image data. Subsequently, the control circuit splits the merged image data. The predetermined compression algorithm may include, for example, at least one of a run length encoding algorithm and a fractal compression algorithm.

In the embodiment of the present disclosure, the first image data and the second image data are merged by the graphics processor, and the merged image data is transmitted to the control chip via the first interface. The control chip splits the merged image data into first image data and third image data, transmits the first image data to the first driving chip via the second interface, and transmits the third image data to the second driving chip via the third interface. The first driving chip controls the first display screen to display the first image according to the first image data. The second driving chip controls the second display screen to display the third image according to the third image data. Through the algorithmic processing of the image data, the first image data and the second image data are merged in the graphics processor, the merged image data may be transmitted to the control chip through only one interface, and then the merged image may be split by the control chip and transmitted to the first driving chip and the second driving chip respectively to drive the first display screen and the second display screen to perform displaying. Therefore, the first display panel and the second display panel may be driven by using only one interface of the graphics processor, and only one transfer protocol is required for data transmission through one interface of the graphics processor, thereby reducing the cost brought by the transfer protocol and also simplifying the structure and connection of the display device.

For the foregoing method embodiments, for the sake of description, they are all expressed as a combination of a series of actions, but those skilled in the art should know that the present disclosure is not limited by the described sequence of actions. According to the present disclosure, some steps may be performed in other order or simultaneously. Those skilled in the art should also know that the embodiments described in the specification are all preferred embodiments, and the involved actions and modules are not necessarily required by the present disclosure.

The various embodiments in the specification are described in a progressive manner. Each embodiment focuses on the differences from other embodiments, and the same or similar parts between the various embodiments may be referred to each other.

Finally, it should be noted that in the present disclosure, relational terms such as first and second are only used to distinguish one entity or operation from another entity or operation, and do not necessarily require or imply that there is any such actual relationship or order between these entities or operations. Moreover, the terms “comprise”, “include” or any other variants thereof are intended to cover non-exclusive inclusion, so that a process, method, product or apparatus including a series of elements not only includes those elements, but also includes other elements not clearly listed of, or further includes elements inherent to this process, method, product or apparatus. If there are no more restrictions, the element defined by the sentence “including a . . . ” does not exclude the existence of other identical elements in the process, method, product or apparatus that includes the element.

The display device and the driving method thereof provided by the present disclosure are described in detail above. Specific examples are used in the present disclosure to illustrate the principles and implementations of the present disclosure. The description of the above embodiments is only to help understand the method and core ideas of the present disclosure. Moreover, for those ordinary skilled in the art, there will be changes in the specific implementation and the scope of application according to the ideas of the present disclosure. In summary, the content of the specification should not be construed as limiting the present disclosure.

1. A display device, comprising:
a graphics processor including a first interface, wherein the graphics processor is configured to: merge first image data and second image data to obtain merged image data, and transmit the merged image data via the first interface;
a control circuit including a second interface and a third interface, wherein the control circuit is configured to: receive the merged image data, split the merged image data into first image data and third image data, transmit the first image data via the second interface, and transmit the third image data via the third interface, wherein the third image data is at least partially the same as the second image data;
a first display panel, configured to receive the first image data, and display a first image based on the first image data; and
a second display panel, configured to receive the third image data, and display a third image based on the third image data.

2. The display device according to claim 1, wherein the first image data comprises M first pixel data, and the second image data comprises N second pixel data, where M is an integer greater than 1, and N is an integer greater than M; and
wherein the graphics processor is configured to replace M second pixel data located at a specified position in the N second pixel data with the M first pixel data based on a first mapping relationship, so that the merged image data includes N-M second pixel data and the M first pixel data, wherein the first mapping relationship comprises a position mapping relationship between the M first pixel data and the M second pixel data.

3. The display device according to claim 2, wherein the control circuit is configured to:
split the merged image data into the M first pixel data and the N-M second pixel data based on the first mapping relationship, so that the first image data includes the M first pixel data, and image data to be processed includes the N-M second pixel data and M pixel voids located at the specified position; and
determine, for each pixel void in the M pixel voids, pixel data for the each pixel void according to second pixel data adjacent to the each pixel void in the N-M second pixel data, and perform data filling at the specified position in the image data to be processed based on the pixel data for the each image void, so as to obtain the third image data.

4. The display device according to claim 2, wherein the M second pixel data at the specified position comprise: M second pixel data for an edge position of a display unit of the second display panel.

5. The display device according to claim 1, wherein the first image data comprises M first pixel data, and the second image data comprises N second pixel data, where M is an integer greater than 1, and N is an integer greater than M; and
wherein the graphics processor is configured to splice the M first pixel data and the N second pixel data based on a second mapping relationship so as to obtain the merged image data, wherein the second mapping relationship comprises: a position mapping relationship of the M first pixel data from the first image data to the merged image data, and a position mapping relationship of the N second pixel data from the second image data to the merged image data; and
wherein the control circuit is configured to split the merged image data into the M first pixel data and the N second pixel data based on the second mapping relationship, so that the first image data includes the M first pixel data, and the third image data includes the N second pixel data, wherein the third image data is the same as the second image data.

6. The display device according to claim 1, wherein,
the graphics processor is further configured to: compress the merged image data based on a predetermined compression algorithm so as to obtain compressed data, and transmit the compressed data to the control circuit via the first interface; and
the control circuit is further configured to decompress the compressed data based on a decompression algorithm for the predetermined compression algorithm so as to obtain the merged image data.

7. The display device according to claim 6, wherein the predetermined compression algorithm comprises at least one of a run length encoding algorithm and a fractal compression algorithm.

8. The display device according to claim 1, wherein the second interface is an MIPI interface, and the third interface is an LVDS interface; and
wherein the control circuit further comprises:
a first control circuit, configured to convert the first image data into MIPI format data and transmit the MIPI format data to the first display panel via the second interface; and
a second control circuit, configured to convert the third image data into LVDS format data and generate a timing control signal, and transmit the LVDS format data and the timing control signal to the second display panel via the third interface.

9. The display device according to claim 8, wherein the first control circuit is a bridge integrated circuit, and the second control circuit is a timing controller.

10. The display device according to claim 1, wherein the first interface is an eDP interface or an HDMI interface.

11. A driving method of a display device performed by the display device according to claim 1, the method comprising:
merging first image data and second image data by using a graphics processor so as to obtain merged image data, and transmitting the merged image data to a control circuit via a first interface;
splitting the merged image data into first image data and third image data by using the control circuit, transmitting the first image data to a first display panel via a second interface, and transmitting the third image data to a second display panel via a third interface, wherein the third image data is at least partially the same as the second image data;
displaying a first image according to the first image data by using the first display panel; and
displaying a third image according to the third image data by using the second display panel.

12. The method according to claim 11, wherein the first image data comprises M first pixel data, and the second image data comprises N second pixel data, where M is an integer greater than 1, and N is an integer greater than M; and
wherein the merging first image data and second image data comprises:
replacing M second pixel data located at a specified position in the N second pixel data with the M first pixel data based on a first mapping relationship, so that the merged image data includes N-M second pixel data and the M first pixel data, wherein the first mapping relationship comprises a position mapping relationship between the M first pixel data and the M second pixel data.

13. The method according to claim 12, wherein the splitting the merged image data into first image data and third image data comprises:
splitting the merged image data into the M first pixel data and the N-M second pixel data based on the first mapping relationship, so that the first image data includes the M first pixel data, and image data to be processed includes the N-M second pixel data and M pixel voids located at the specified position; and
determining, for each pixel void in the M pixel voids, pixel data for the each pixel void according to second pixel data adjacent to the each pixel void in the N-M second pixel data, and performing data filling at the specified position in the image data to be processed based on the pixel data for the each image void, so as to obtain the third image data.

14. The method according to claim 13, wherein the M second pixel data at the specified position comprises M second pixel data for an edge area of the second display panel.

15. The method according to claim 11, wherein the first image data comprises M first pixel data, and the second image data comprises N second pixel data, where M is an integer greater than 1, and N is an integer greater than M; and
wherein the merging first image data and second image data comprises:
splicing the M first pixel data and the N second pixel data based on a second mapping relationship so as to obtain the merged image data, wherein the second mapping relationship comprises: a position mapping relationship of the M first pixel data from the first image data to the merged image data, and a position mapping relationship of the N second pixel data from the second image data to the merged image data; and
wherein the splitting the merged image data into first image data and third image data comprises:
splitting the merged image data into the M first pixel data and the N second pixel data based on the second mapping relationship, so that the first image data includes the M first pixel data, and the third image data includes the N second pixel data, wherein the third image data is the same as the second image data.

16. The method according to claim 11, further comprising:
compressing the merged image data based on a predetermined compression algorithm by using the graphics processor so as to obtain compressed data; and
decompressing the compressed data based on a decompression algorithm for the predetermined compression algorithm by using the control circuit so as to obtain the merged image data;
wherein the transmitting the merged image data to the control circuit via a first interface comprises transmitting the compressed data to the control circuit via the first interface.

17. The method according to claim 16, wherein the predetermined compression algorithm comprises at least one of a run length encoding algorithm and a fractal compression algorithm.
